(19) United States
(12) Patent Application Publication
(10) Pub. No.: US 2022/0011767 A1
(43) Pub. Date: Jan. 13, 2022

(54) METHOD FOR THE AT LEAST SEMI-AUTOMATED GUIDANCE OF A MOTOR VEHICLE

(71) Applicant: Robert Bosch GmbH, Stuttgart (DE)

(72) Inventors: Rolf Nicodemus, Bietigheim-Bissingen (DE); Stefan Nordbruch, Leonberg (DE)

(21) Appl. No.: 17/292,644

(22) PCT Filed: Dec. 5, 2019
(86) PCT No.: PCT/EP2019/083812

§ 371 Date: May 10, 2021

(30) Foreign Application Priority Data
Dec. 28, 2018 (DE) 10 2018 251 771.1

(51) Int. Cl. G05D 1/00

(52) U.S. Cl. CPC G05D 1/0011; G05D 2201/0213; G05D 1/0061

(57) ABSTRACT

A method for the at least semi-automated guidance of a motor vehicle. The method includes: receiving request signals, which represent a request from the motor vehicle that it is to be remotely controlled in order to guide the motor vehicle in an at least semi-automated manner; checking, in response to the receipt of the request signals, whether the request can be met; if so, generating remote control signals for the at least semi-automated remote control of a lateral and longitudinal guidance of the motor vehicle; and outputting the generated remote control signals in order to guide the motor vehicle in an at least semi-automated manner on the basis of the generated remote control signals.

### FIELD

The present invention relates to two methods for the at least semi-automated guidance of a motor vehicle. The present invention also relates to an apparatus, a computer program, and a machine-readable storage medium.

### BACKGROUND INFORMATION

German Patent Application No. DE 10 2013 016 436 A1 describes a method for operating a safety system of a motor vehicle.

German Patent Application No. DE 10 2016 218 382 A1 describes a method and apparatuses for the autonomous travel operation of a vehicle in an emergency mode.

German Patent Application No. DE 10 2017 200 871 A1 No. describes a cooperative vehicle control.

European Patent Application No. EP 2 216 197 A1 describes a method for controlling a driver assistance system and a driver assistance system.

### SUMMARY

An object of the present invention is to provide efficient, at least semi-automated guidance of a motor vehicle.

This objective may be achieved in accordance with example embodiments of the present invention. Advantageous embodiments of the present invention are described herein.

In accordance with a first aspect, a method is provided for the at least semi-automated guidance of a motor vehicle. In accordance with an example embodiment of the present invention, the method includes the following steps:

Receiving request signals representing a request from the motor vehicle that it be guided by remote control in an at least semi-automated manner from a remote location;

in response to receipt of the request signals, checking whether the request may be met;

if so, generating remote control signals for the at least semi-automated remote control of a lateral and longitudinal guidance of the motor vehicle, and

outputting the generated remote control signals in order to guide the motor vehicle in an at least semi-automated manner from a remote location on the basis of the generated remote control signals.

In accordance with a second aspect, a method for the at least semi-automated guidance of a motor vehicle is provided. In accordance with an example embodiment of the present invention, the method includes the following steps:

during an at least semi-automated, remotely controlled, lateral and longitudinal guidance of the motor vehicle, in order to guide the motor vehicle in an at least semi-automated manner from a remote location, receiving request signals which represents a request to the remote-controlled motor vehicle and/or to a driver of the remote-controlled motor vehicle, that the at least semi-automated, remote guidance is to be transferred back to the motor vehicle or to the driver;

in response to receipt of the signals, checking whether the request may be met;

if so, generating control signals for the at least semi-automated control of a lateral and longitudinal guidance of the motor vehicle, and

outputting the generated control signals in order to guide the motor vehicle in an at least semi-automated manner on the basis of the generated control signals.

A third aspect provides an apparatus which is adapted for performing all steps of the method in accordance with the first and/or the second aspect of the present invention.

A fourth aspect provides a computer program which includes instructions which, upon execution of the computer program by a computer, for example, by the apparatus in accordance with the third aspect, prompt the computer to execute a method in accordance with the first and/or second aspect of the present invention.

A fifth aspect provides a machine-readable storage medium upon which the computer program according to the fourth aspect is stored.

The present invention is based on the realization that the above objective may be achieved by it being checked prior to a remote control of the motor vehicle whether the motor vehicle is able to be remotely controlled at all, respectively prior to the at least semi-automated guidance being transferred back to the motor vehicle, it being checked in the case of remote control whether the motor vehicle is ready to take over the guidance, respectively whether the driver is prepared to monitor the transfer back, for example.

A technical advantage may thereby be derived, for example, that the motor vehicle is able to be efficiently guided in an at least semi-automated manner.

Specifically, the present invention provided herein results, namely, in a technical advantage that the following scenario may be able to be run through efficiently:

There are situations which are difficult, if not impossible for a motor vehicle to handle that is guided in an at least semi-automated manner. Such situations may be intersections, for instance, which are generally complex, for example, because a road routing of intersecting roads at the intersection may not be visible to a driving-environment sensor system of the motor vehicle.

Such situations include hilltops, for example, since here as well, it is hardly feasible or not possible to sense a routing of the road behind the hilltop.

Such situations may include people congregating at a bus stop, for example.

If, in such a situation, the motor vehicle were still guided in an at least semi-automated manner, there could be an increase in the risk of errors and thus risk of accidents.

At this stage, example embodiments of the present invention may make it possible for the motor vehicle to be remotely controlled in such situations, so that these situations, which would be difficult, if not impossible for the motor vehicle itself to handle, may be handled efficiently.

An technical advantage may thereby be derived, for example, that a risk of errors and thus of accidents may be efficiently reduced.

Thus, in summary, a technical advantage may thereby derived, in particular that example embodiments of the present invention provide efficient, at least semi-automated guidance of a motor vehicle.

The formulation “at least semi-automated control, respectively guidance” encompasses the following cases: semi-automated control, respectively guidance; highly automated control, respectively guidance; fully automated control, respectively guidance; driverless control, respectively guidance; remote control of the motor vehicle.

Semi-automated control, respectively guidance means that, in a specific application (for example: driving on an expressway, driving within a parking lot, passing an object, driving within a lane defined by lane markings), a longitudinal and transverse guidance of the motor vehicle is automatically controlled. It is not necessary that a driver of the motor vehicle himself/herself manually control the longitudinal and transverse guidance thereof. However, he/she must continuously monitor the automatic control of the longitudinal and transverse guidance in order to be able to manually intervene if needed.

Highly automated control, respectively guidance means that, in a specific application (for example: driving on an expressway, driving within a parking lot, passing an object, driving within a lane defined by lane markings), a longitudinal and transverse guidance of the motor vehicle is automatically controlled. It is not necessary that a driver of the motor vehicle himself/herself manually control the longitudinal and transverse guidance thereof. It is not necessary that the driver continuously monitor the automatic control of the longitudinal and transverse guidance to be able to manually intervene if needed. If necessary, a request is automatically issued to the driver for him/her to take over the control of the longitudinal and transverse guidance. Potentially, therefore, the driver must be able to take over the control of the longitudinal and transverse guidance.

Fully automated control, respectively guidance means that, in a specific application (for example: driving on an expressway, driving within a parking lot, passing an object, driving within a lane defined by lane markings), a longitudinal and transverse guidance of the motor vehicle is automatically controlled. It is not necessary that a driver of the motor vehicle himself/herself manually control the longitudinal and transverse guidance thereof. It is not necessary that the driver monitor the automatic control of the longitudinal and transverse guidance to be able to manually intervene if needed. There is no need for the driver in the specific application.

Driverless control, respectively guidance means that, regardless of a specific application (for example: driving on an expressway, driving within a parking lot, passing an object, driving within a lane defined by lane markings), a longitudinal and transverse guidance of the motor vehicle is automatically controlled. It is not necessary that a driver of the motor vehicle himself/herself manually control the longitudinal and transverse guidance thereof. It is not necessary that the driver monitor the automatic control of the longitudinal and transverse guidance to be able to manually intervene if needed. Thus, the longitudinal and transverse guidance of the vehicle are automatically controlled, for example, for all road types, velocity ranges and environmental conditions. Thus, the entire driving task of the driver is automatically taken over. Therefore, he/she is no longer needed. Thus, even without a driver, the motor vehicle may drive from any starting position to any target position. Potential problems are automatically resolved, thus without the aid of the driver.

Remotely controlling the motor vehicle means that a transverse and longitudinal guidance thereof is remotely controlled. This means, for example, that remote control signals for remotely controlling the transverse and longitudinal guidance are transmitted to the motor vehicle. The remote control is carried out, for example, by a remote control device.

A specific embodiment of the present invention provides that the remote control of the motor vehicle is begun either while the motor vehicle is moving or while it is stationary.

A specific embodiment of the present invention provides that the remote control of the motor vehicle is terminated either while the motor vehicle is moving or while it is stationary.

A specific embodiment of the present invention provides that indicator signals are output, which represent an indication that an at least semi-automated guidance of a motor vehicle from a remote location is possible, respectively specified, for example, by a jurisdictional authority, respectively on the basis of legal regulations.

The technical advantage may thereby be derived, for example, that a motor vehicle is able to efficiently obtain knowledge that an at least semi-automated guidance of a motor vehicle from a remote location is possible, respectively specified.

A specific embodiment of the present invention provides that the request includes a starting position or a starting area where or within which the remote control of the motor vehicle is to begin when the motor vehicle is at the starting position or within the starting area; if the request is able to be met, the remote control signals being generated and output in such a way that the remote control may begin when the motor vehicle is in the starting position or within the starting area.

A technical advantage may thereby be derived, for example, that the remote control of the motor vehicle may be efficiently begun. Specifically, the technical advantage may thereby be derived that it is already known in advance where the remote control of the motor vehicle is to begin. This makes it possible, for example, to efficiently implement a planning required for this purpose.

A specific embodiment of the present invention provides that the request includes an end position or an end area where or within which the remote control of the motor vehicle is to be terminated when the motor vehicle is located at the end position or within the end area; if the request is able to be met, the remote control signals being generated and output in such a way that the remote control may be terminated when the motor vehicle is located at the end position or within the end area.

A technical advantage may thereby be derived, for example, that it is already known in advance where the remote control of the motor vehicle is to be stopped. This advantageously makes it possible, for example, for a suitable planning to be efficiently implemented.

A specific embodiment of the present invention provides that the request includes a starting time when the remote control of the motor vehicle is to begin; if the request is able to be met, the remote control signals being generated and output in such a way that the remote control may be begun at the starting time.

A technical advantage may thereby be derived, for example, that the remote control may be carried out efficiently.

A specific embodiment of the present invention provides that the request includes an end time when the remote control is to be terminated; if the request is able to be met, the remote control signals being generated and output in such a way that the remote control may be terminated at the end time.

A technical advantage may thereby be derived, for example, that the remote control may be carried out efficiently.

The starting position, respectively the starting area, and the end position, respectively the end area are, for example, two successive positions, respectively two successive areas along a route of the motor vehicle.

The route is prepared by a navigation system, for example.

This means, for example, that the request, therefore, includes that the motor vehicle is to be remotely controlled on a predetermined section of a route. This predetermined section is defined by the starting position, respectively the starting area, and the end position, respectively the end area.

The starting time described above, respectively end time may be a predicted starting time, respectively a predicted end time, for example.

A predicted starting time refers to a time when the motor vehicle arrives at the starting position, respectively the starting area with a predetermined likelihood.

This holds analogously for the predicted end time. Such a predicted end time refers to a time when the motor vehicle arrives with a predetermined likelihood at the end position, respectively end area.

This means, for example, that a movement of the motor vehicle is predicted in order to predict the starting, respectively end times.

A specific embodiment of the present invention provides that, prior to termination of the remote control of the motor vehicle, further request signals are generated and output. They represent a further request to the motor vehicle and/or to a driver thereof that the at least semi-automated, remote guidance is to be transferred back to the motor vehicle or to the driver; the remote control of the motor vehicle being terminated as a function of a response to the further request.

A technical advantage may thereby be derived, for example, that the remote control may be efficiently terminated. Specifically, A technical advantage may thereby be derived that the motor vehicle, respectively the driver thereof may be efficiently informed that the remote control is terminated promptly.

In accordance with a specific embodiment of the present invention, if a response from the motor vehicle and/or the driver to the further request is absent, the generation of the remote control signals includes generating those for the remotely controlled transfer of the motor vehicle to a safe state in order to transfer the motor vehicle by remote control to a safe state on the basis of the generated remote control signals.

A technical advantage may thereby be derived, for example, that it is possible to efficiently respond to the absence of a response from the motor vehicle and/or the driver thereof.

In accordance with another specific embodiment of the present invention, if a response from the motor vehicle and/or the driver to the further request is absent, light-signal system control signals for controlling one or a plurality of light signal systems located in an area surrounding the motor vehicle are generated and output in such a way that when one or a plurality of light signal systems are controlled, they are able to block traffic for the motor vehicle via the signal patterns thereof.

A technical advantage may thereby be derived, for example, that it is possible to efficiently respond to an absence of a response from the motor vehicle and/or the driver thereof.

A specific embodiment of the present invention provides that checking whether the request may be met includes checking whether one or a plurality of conditions is/are met, the request being met only if one or more or a plurality or all of the one or the plurality of conditions are met.

A technical advantage may thereby be derived, for example, that the checking may be efficiently performed. In particular, the conditions under which remote control of the motor vehicle is permissible may thereby be efficiently determined.

In accordance with a specific embodiment of the present invention, the one or the plurality of conditions is/are an element selected from the following group of conditions, respectively: An apparatus for the at least semi-automated guidance of a motor vehicle, which performs the steps of the method for the at least semi-automated guidance thereof, is in operation and fully functional; The actual weather corresponds to a desired weather; The actual traffic condition in an area surrounding the motor vehicle corresponds to a desired traffic condition; the actual traffic infrastructure in an area surrounding the motor vehicle corresponds to a desired traffic infrastructure; The computing capacity of the apparatus for the at least semi-automated guidance of a motor vehicle is equal to or greater than or equal to a predetermined computing capacity threshold value, The apparatus for the at least semi-automated guidance of a motor vehicle is able to remotely control the requesting motor vehicle; The requesting motor vehicle is capable of being remotely controlled; Necessary conditions for a proper functioning of the remote control are fulfilled; The implementation of the remote control has been paid.

A technical advantage may thereby be derived, for example, that different situations may be efficiently responded to.

A specific embodiment of the present invention provides that, in the case of the method in accordance with the second aspect, the request signals are the further request signals which, in a specific embodiment, may be provided in accordance with the first aspect.

Technical functionalities of the apparatus are derived analogously from the corresponding functionalities of the method and vice versa.

A specific embodiment of the method in accordance with the second aspect of the present invention provides that checking whether the request may be met includes checking whether one or a plurality of conditions is/are met, the request being met only if one or more or a plurality or all of the one or the plurality of conditions are met.

A specific embodiment of the method in accordance with the second aspect of the present invention provides that the one or the plurality of conditions is/are an element selected from the following group of conditions, respectively: An onboard apparatus for the at least semi-automated guidance of a motor vehicle, which is able to perform the steps of the method for the at least semi-automated guidance of a motor vehicle, is in operation and fully functional; The actual weather corresponds to a desired weather; The actual traffic condition in an area surrounding the motor vehicle corresponds to a desired traffic condition; the actual traffic infrastructure in an area surrounding the motor vehicle corresponds to a desired traffic infrastructure; The computing capacity of the onboard apparatus for the at least semi-automated guidance of a motor vehicle is equal to or greater than or equal to a predetermined computing capacity threshold value, The onboard apparatus for the at least semi-automated guidance of a motor vehicle is able to take over the at least semi-automated guidance.

In accordance with a specific embodiment of the present invention, the motor vehicle is encompassed by a robot or is in the form of a robot which may be used in a logistics plant, for example.

In accordance with a specific embodiment, the motor vehicle is a shuttle.

The abbreviation “resp.” stands for “respectively.”

The formulation “resp.” stands for “respectively,” in particular.

The formulation “respectively” stands for “and/or,” in particular.

In a specific embodiment of the present invention, the method in accordance with the first aspect and/or the method in accordance with the second aspect are/is a computer-implemented method.

A specific embodiment of the present invention provides that the motor vehicle, from which the request originates, is stationary or manually driven by a driver.

Exemplary embodiments of the present invention are illustrated in the figures and explained in greater detail below.

### BRIEF DESCRIPTION OF THE DRAWINGS

FIG. 1 shows a flow chart of a method for the at least semi-automated guidance of a motor vehicle in accordance with the first aspect of a first specific embodiment of the present invention.

FIG. 2 shows a flow chart of a method for the at least semi-automated guidance of a motor vehicle in accordance with the second aspect of a first embodiment of the present invention.

FIG. 3 shows an apparatus, which is adapted for performing all steps of the method in accordance with the first and/or the second aspect of the present invention.

FIG. 4 shows a machine-readable storage medium in accordance with an example embodiment of the present invention.

FIG. 5 is an exemplary use of an example embodiment of the present invention.

### DETAILED DESCRIPTION OF EXAMPLE EMBODIMENTS

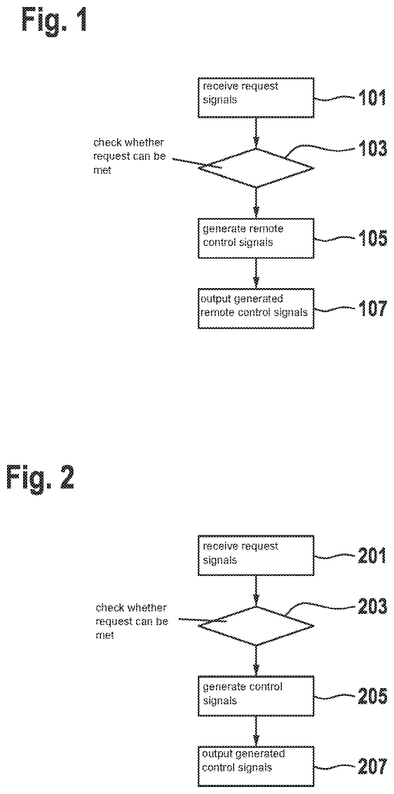

FIG. 1 shows a flow chart of a method for the at least semi-automated guidance of a motor vehicle, including the following steps:

receiving 101 request signals, which represent a request from the motor vehicle that it is to be remotely controlled in order to guide the motor vehicle in an at least semi-automated manner; checking 103,

in response to receipt of the request signals, whether the request may be met;

if so, generating 105 remote control signals for the at least semi-automated remote control of a lateral and longitudinal guidance of the motor vehicle; and

outputting 107 the generated remote control signals in order to guide the motor vehicle in an at least semi-automated manner from a remote location on the basis of the generated remote control signals.

FIG. 2 shows a flow chart of a method for the at least semi-automated guidance of a motor vehicle, including the following steps:

in order to guide the motor vehicle in an at least semi-automated manner during an at least semi-automated, remotely controlled, lateral and longitudinal guidance of the motor vehicle, receiving 201 request signals representing a request to the remote-controlled motor vehicle and/or to a driver of the remote-controlled motor vehicle that the at least semi-automated, remote guidance is to be transferred back to the motor vehicle or to the driver;

checking 203, in response to receipt of the request signals, whether the request may be met;

if so, generating 205 control signals for the at least semi-automated control of a lateral and longitudinal guidance of the motor vehicle; and

outputting 207 the generated control signals in order to guide the motor vehicle in an at least semi-automated manner on the basis of the generated remote control signals.

A specific embodiment (not shown) provides that, if the checking in accordance with step 103, respectively 203 reveals that it is not possible to meet the request, response signals are generated and output, which represent a response that it is not possible to meet the request.

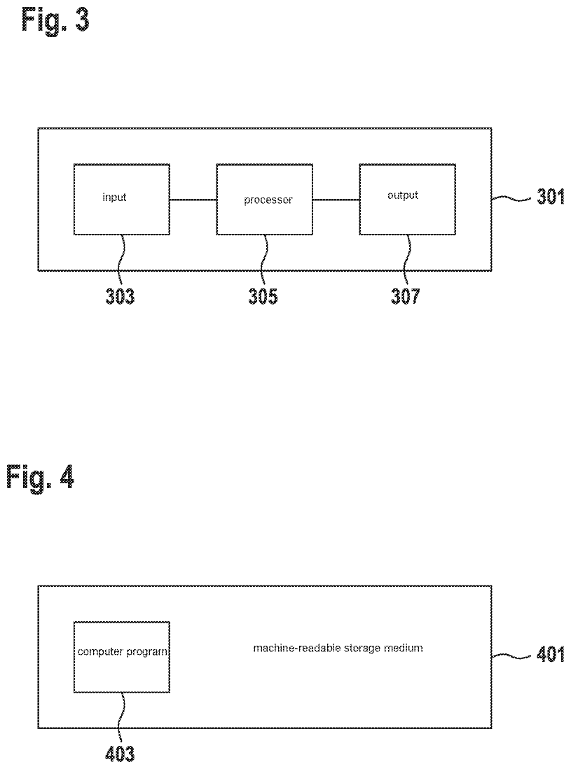

FIG. 3 depicts an apparatus 301.

Apparatus 301 is adapted for performing all steps of the method in accordance with the first and/or second aspect.

Apparatus 301 includes an input 303, which is adapted for receiving the request signals described above and/or in the following.

Furthermore, apparatus 301 includes a processor 305, which is adapted for performing the checking step described above and/or in the following. Furthermore, processor 305 is adapted for performing the generating step described above and/or in the following.

Furthermore, apparatus 301 includes an output 307, which is adapted for outputting the generated control signals.

Signals, which are received via apparatus 301, are generally received, in particular via input 303. Input 303 is correspondingly adapted for this purpose, in particular.

Signals, which are output via apparatus 301, are output, in particular via output 307. Output 307 is correspondingly adapted for this purpose, in particular.

Thus, input 303, respectively output 307 are adapted for receiving, respectively outputting corresponding signals.

In accordance with a specific embodiment, a plurality of processors are provided instead of the one processor 305.

FIG. 4 depicts a machine-readable storage medium 401.

A computer program 403 is stored on machine-readable storage medium 401. Computer program 403 includes instructions which, upon execution of computer program 403 by a computer, prompt it to execute a method in accordance with the first and/or second aspect.

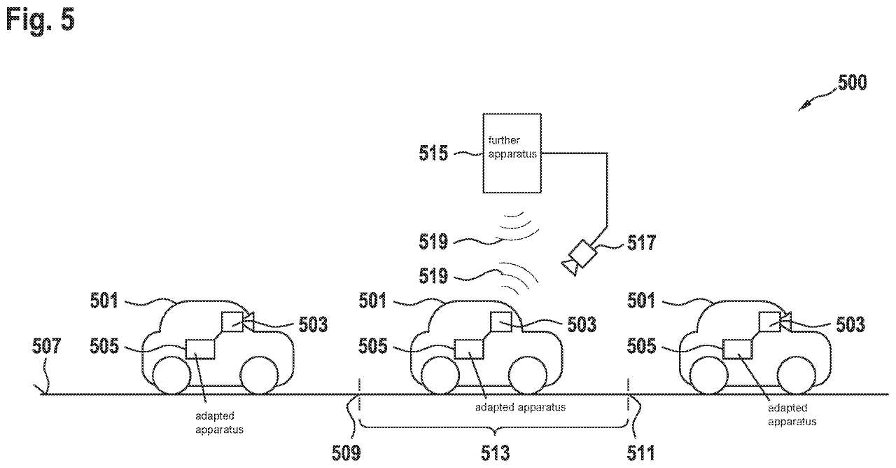

FIG. 5 illustrates an application scenario 500 of the concept described here.

Application scenario 500 exemplarily provides a motor vehicle 501, which includes a video camera 503 and includes an apparatus 505 that is adapted for performing all steps of the method in accordance with the second aspect, motor vehicle 501 being driven on a road 507.

In accordance with the specific embodiment shown here, apparatus 505 is adapted for guiding motor vehicle 501 in an at least semi-automated manner. This means that apparatus 505 is adapted for controlling a transverse and longitudinal guidance of motor vehicle 501 in an at least semi-automated manner.

This control is implemented, inter alia, on the basis of a recording by video camera 503 of an area surrounding motor vehicle 501.

Here, video camera 503 represents a driving-environment sensor system (not shown in greater detail) of motor vehicle 501. Such a driving-environment sensor system includes one or a plurality of driving environment sensors.

In the context of the Specification, a driving environment sensor is one of the following, for example: a radar sensor, a lidar sensor, a video sensor, an infrared sensor, a magnetic field sensor, an ultrasonic sensor or a magnetic-field sensor.

This means, in particular, that motor vehicle 501 may include a driving-environment sensor system that has one or a plurality of driving environment sensors.

Reference numerals 509, 511 designate two successive locations, respectively positions on road 507 relative to a direction of travel of motor vehicle 501.

Thus, these two locations 509, 511 define a section 513 of a route of motor vehicle 501.

Within section 513, it is not possible for motor vehicle 501 to drive itself in an at least semi-automated manner.

This means that, within section 513, apparatus 505 is not able to guide motor vehicle 501 in an at least semi-automated manner.

This may be because a hilltop is located within section 513, for example, so that the driving environment sensors of motor vehicle 501 are not able to “look” behind this hilltop. This means, therefore, that the driving environment sensors of motor vehicle 501 are not able to sense a road located behind the hilltop relative to the direction of travel of motor vehicle 501.

The concept described here provides that, within section 513, motor vehicle 501 is guided in an at least semi-automated manner. Thus, this means that motor vehicle 501 is remotely controlled within section 513.

For this purpose, another apparatus 515 is provided which is adapted for performing all steps of the method in accordance with the first aspect.

Another video camera 517 is configured within section 513 that is able to record an area surrounding motor vehicle 501. In particular, such a video camera 517 may record areas within section 513 that are not able to be recorded by a driving-environment sensor system of motor vehicle 501.

Analogously to video camera 503 of motor vehicle 501, additional video camera 517 represents a further driving-environment sensor system including one or a plurality of driving environment sensors which are spatially distributed within section 513.

To remotely control motor vehicle 501, apparatus 515 uses the driving-environment sensor data corresponding to the particular recording of the driving environment sensors.

A communication between motor vehicle 501 and apparatus 515 is symbolically marked by undulated elements 519.

Even before motor vehicle 501 reaches position 509, which corresponds to the starting position described above, apparatus 505 transmits request signals to other apparatus 515; these request signals representing a request from motor vehicle 501 that motor vehicle 501 is to be remotely controlled within section 513.

In response to receipt of the request signals, apparatus 515 checks whether it is possible for the request to be met. If so, apparatus 515 generates corresponding remote control signals and outputs the same, in order to guide the motor vehicle within section 513 in an at least semi-automated manner from a remote location on the basis of the generated remote control signals.

For example, apparatus 515 transmits these remote control signals to motor vehicle 501, more precisely to apparatus 505.

Generally this means, therefore, that outputting the generated remote control signals may include transmitting the generated remote control signals over a wireless communication network to motor vehicle 501, for example.

Analogously, the same holds generally for receiving request signals which may be received over the wireless communication network.

For the communication between apparatus 505 and further apparatus 515, it is provided, in particular that apparatuses 505, 515 include a communication interface which is adapted for transmitting, respectively receiving corresponding signals.

Thus, this means that, before starting position 509, a responsibility for the motor vehicle guidance remains with motor vehicle 501: Within section 513, further apparatus 515 has the responsibility for the motor vehicle guidance.

This means, therefore, that the responsibility for guiding the motor vehicle is transferred from motor vehicle 501 to further apparatus 515.

The request from motor vehicle 501 also includes second position 511 where the remote control is to be stopped. Position 511 corresponds to the end position described above.

Thus, additional apparatus 515 knows up to which location along the route of motor vehicle 501, motor vehicle 501 is to be remotely controlled.

Shortly before motor vehicle 501 reaches end position 511, thus before a termination of the remote control of motor vehicle 501, further apparatus 515 generates further request signals and outputs the same, these additional request signals representing a further request to motor vehicle 501 and/or to a driver thereof that the at least semi-automated, remote guidance is to be transferred back to motor vehicle 501 or to the driver.

The remote control of motor vehicle 501 is then terminated as a function of a response to this further request.

In response to a receipt of the further request signals, apparatus 505 checks whether this further request may be met, for example. If so, apparatus 505 acknowledges, respectively confirms or acknowledges the further request transmitting a corresponding acknowledgement message, respectively confirmation message to further apparatus 515 over the wireless communication network, for example.

If motor vehicle 501 then reaches end position 511, the remote control is terminated on the part of further apparatus 515, and motor vehicle 501 itself again takes over the at least semi-automated guidance thereof.

If, for example, additional apparatus 515 does not receive an acknowledgement message, respectively confirmation message indicative thereof from motor vehicle 501, it is provided, for example, that additional apparatus 515 remotely transfers motor vehicle 501 to a safe state.

A safe state is a standstill, for example. Thus, this means that additional apparatus 515 stops motor vehicle 501 by remote control if, for example, no corresponding acknowledgement message, respectively confirmation message is received.

In summary, the concept described here is based, inter alia, in particular on one or a plurality of changes in responsibility for the driving being made during a drive. The responsibility relates, for example, to the areas of safety, planning and regulation.

That means that the motor vehicle itself basically drives in an at least semi-automated, in particular highly automated manner. This means, for example, that, inter alia, the responsibility, planning of the driving tasks, the control of the driving task, the safety responsibility, etc. reside with the motor vehicle, respectively are implemented. Besides onboard data/intelligence, etc., external data, suggestions, etc. (for example, from an infrastructure/infrastructure system) may be included. However, the motor vehicle (decision maker) always has “the last word.”

For areas which are too complex (currently) do not suffice (qualitatively) or are not able to be realized at all, etc., the driving process/responsibility during the drive is transferred to an external system (further apparatus 515). This means that from here on, the external system has the responsibility, planning of the driving tasks, the control of the driving task, the responsibility for safety, etc. (decision maker).

The tasks are thereby performed with the aid of an external infrastructure/an external infrastructure system. External data, suggestions, etc. (from the point of view of the external system) from the motor vehicle to be driven remotely, as well as from other motor vehicles, as well as from other external systems/sources may include the system.

This means the process is as follows, for example:

1. The motor vehicle itself drives in a highly automated manner. (Decision maker/responsibility resides with the motor vehicle.)

2. It is ascertained and/or it is known in advance that there is a situation/section on the route where the motor vehicle itself is not able to drive or drive well enough.

3. It is ascertained and/or known that an external system (further apparatus 515) is available in this section.

4. A request is made to the external system as to whether the motor vehicle may be taken over, thus, whether it may be remotely controlled within the section.

5. If the external system agrees (thus, if it is possible for the request to be met):
a. if a transfer of responsibility takes place (motor vehicle to the external system), preferably, at a defined location, respectively in a defined area.
b. If the responsibility is successfully transferred, the motor vehicle is driven by the external system (responsibility resides with the external system).
c. Subsequently to the situation/section, the responsibility is transferred back (again to the motor vehicle), preferably, at a defined location, respectively in a defined area.
d. If the responsibility is successfully transferred, the motor vehicle again drives in a highly automated manner (motor vehicle-based; responsibility resides with the motor vehicle).

Another variant may provide that the driving process starts directly with the responsibility for the external system, thus:

1. The motor vehicle is driven manually by the driver or is still stationary (responsibility resides with the driver, respectively “no one has the responsibility yet”).

2. It is ascertained and/or it is known in advance that there is a situation/section on the route where the motor vehicle is not able to drive or drive well enough.

3. A request is made to the external system as to whether the motor vehicle may be taken over.

4. If the external system agrees:
a. steps as above in 5.

Another variant may provide that the driving process is terminated by the external system following the drive. This means that the motor vehicle was shut off (stopped, for example, or the motor vehicle was parked in a parking space).

Another specific embodiment provides that the external system transfers the driving process to the driver. This is because the driver wanted to do so, for example, or because a driving process is neither possible via highly automated control by the motor vehicle nor via the external system (planned or/unplanned).

If any transfers do not function, either the transfer is made to the driver, and/or the motor vehicle is put in a safe state (for example, standstill).

If errors are detected in the systems—regardless of whether during the highly automated drive of the motor vehicle itself or the drive controlled by the external system, either the motor vehicle is transferred to the driver, and/or the motor vehicle is put in the safe state (for example, standstill). Generally, this means that a specific embodiment provides that the motor vehicle is transferred to a safe state in response to detection of an error, respectively the responsibility be transferred to the driver.

In another specific embodiment, a take over by the external system may also be requested and planned already at the beginning of or prior to the drive. In such a case, a renewed confirmation is optimally made, for example, just before the section (something may have changed).

In another specific embodiment, a plurality of areas may be requested and/or planned.

When the takeover by the external system is requested, the desired route is preferably transferred as well (if indicated, there may be a plurality of ways to drive through the section).

The system checks whether the desired route is possible. If the desired route is not possible, alternatives may be optionally determined. They are communicated to the motor vehicle (thus, possibly to the driver). In an additional step, the motor vehicle (and/or the driver) may accept or reject these alternatives, for example.

Further data, such as vehicle details, etc., are preferably also transmitted to the system for the planning and implementation, respectively regularly exchanged therewith and/or upon request.

Information about the areas and the properties thereof are retrievable, inter alia, in (cloud) data, maps, criteria, types of communication, etc. They are advantageously always up-to-date and reflect the current status, which may change. For example, a new area is provided, an old one adapted or no longer present.

The external system for guiding the vehicle includes the following, for example, respectively has the following structure, respectively assumes the following, for example:
driving environment sensors (video, radar, lidar, induction loops, etc.)
   stationary driving environment sensors
   movable driving environment sensors (for example, drones)
   for example, driving environment sensors of motor vehicles (for example, the driving environment sensors of the motor vehicle to be remotely controlled and/or driving environment sensors of further motor vehicles).
the section, within which the motor vehicle is to be remotely controlled, is known,
The decision-making system may only be distributed on site, in the “cloud” (on site, cloud).
Individual analyses may also be performed, for example, in the sensors/intermediate systems.
Communication with motor vehicles via mobile communications, WLAN, generally via wireless communication networks.
The system preferably still affects traffic infrastructure (light signal systems, etc.) in order to simplify/optimize the driving process.

All data/actions etc. are preferably recorded (at a minimum, temporarily) for further analysis, optimizations, etc., but also for documentation—for example, in the event of accidents.

In accordance with a specific embodiment, before responsibility is transferred from the motor vehicle to the external system, it is checked whether the external system is able to assume this responsibility.

The analysis for the “whether” is thereby performed via/on the basis of criteria/data.

In the process, the following is analyzed (all or some of them):
Is the external system in operation and fully functional at the requested/predicted time?
Is the requested section made available as a service (service means remote control of the requesting motor vehicle) at the time? Do the weather conditions at the requested/predicted time allow the service?
Does the traffic at the requested/predicted time allow the service?
For example, at rush hour, it is possible that the service could not be offered (for example, that there could be limits).
Does the infrastructure (roads) allow the service?
For example, construction sites, maintenance, events, etc. may make remote control more difficult, respectively impossible.
Is the external system able to still process the vehicle in the requested/predicted time with regard to the limits specific thereto (for example, computing power)?
For example, could only a maximum number of motor vehicles to be remotely controlled be permitted?
Are there too many motor vehicles to be controlled in one section? Do problems arise due to possibly “congruent” routes of the motor vehicles to be controlled?
Do the system and the motor vehicle “match” (probably have different configurations/generations/etc.)?
Is the motor vehicle currently able to be controlled (all systems OK in the motor vehicle)?
Is the motor vehicle permitted for service for the system in general/for the section?
For example, could there have been problems in the past for the particular motor vehicle, causing the motor vehicle to be locked?
Do the technical conditions (in the motor vehicle, in the external system, in the cooperation, in the communication, etc.) work (for example, by a checking)?
Was the service paid for?

Depending on one or a plurality of answers to the above questions, it is then decided, in particular whether the request may be met.

This means the process is as follows, for example:
The “transfer of responsibility” service is requested for the method for a certain section
   for soon/immediately
   for a defined time/time window
The system provides an analysis of the transfer to criteria/data
The system returns the result
   possibly including alternatives regarding time, section (starting position,—size/length), driving conditions, route, . . .

Historical data are preferably also taken into consideration in the computations (for example, weather, traffic). For example, every Monday before Christmas, the traffic is in a certain state, respectively a certain number of motor vehicles would like to use the service.

For the sake of optimization, the results, analyses etc., including the conditions are stored and made available for subsequent analyses (learning behavior).

In accordance with a specific embodiment of the present invention, before the responsibility is transferred from the external system to the motor vehicle, it is checked whether the motor vehicle is able to assume this responsibility.

The analysis for the “whether” is thereby performed via/on the basis of criteria/data. In the process, the following is analyzed (all or some of them or others), for example:
After the section, is highly automated, respectively motor vehicle-based driving possible?
Has this section been approved in general and/or at the time?
Do the weather conditions at the requested/predicted time allow a motor vehicle-based drive?
Does the traffic at the requested/predicted time allow highly automated, respectively motor vehicle-based driving? At rush hour, for example, it could be that the motor vehicle-based driving is not allowed.
Does the infrastructure (roads) allow the service? In other words, are construction sites, maintenance, events, etc. known to the motor vehicle/external system?
Is the motor vehicle currently able to be driven in a highly automated manner (all systems OK in the motor vehicle)?

Depending on one or a plurality of answers to the above questions, it is then decided, in particular whether the request may be met.

This means the process is as follows, for example:
The “transfer of responsibility” service is requested for the method
   for soon/immediately
   for a defined time/time window
(As the later responsible party/decision maker), the motor vehicle provides an analysis of the transfer to criteria/data
   It advantageously thereby consults data etc. from external sources as well (external system, other vehicles, etc.)
The motor vehicle returns the result

If the motor vehicle is not ready, actions will then be subsequently initiated by the infrastructure and/or by the motor vehicle, for example. At a minimum, respectively and/or:
request to driver whether he/she is taking over
planning and implementation of measures that put the motor vehicle in the safe state (stationary; for example, at defined locations)
information from “service personnel”
initiation of safety measures (for example, “blocking” of roads by signal systems)

Historical data are preferably also taken into consideration in the computations (for example, weather, traffic). For example, there is traffic every Monday before Christmas, X vehicles would like to use the service . . .

For the sake of optimization, the results, analyses etc., including the conditions are stored and made available for subsequent analyses (learning behavior).

1-16. (canceled)

17. A method for the at least semi-automated guidance of a motor vehicle, comprising the following steps:
receiving request signals, which represent a request from the motor vehicle that the motor vehicle is to be remotely controlled in order for the motor vehicle to be guided in an at least semi-automated manner;
checking, in response to receipt of the request signals, whether the request may be met;
based on the request being able to be met, generating remote control signals for the at least semi-automated remote control of a lateral and longitudinal guidance of the motor vehicle; and
outputting the generated remote control signals to guide the motor vehicle in an at least semi-automated manner from a remote location based on the generated remote control signals.

18. The method as recited in claim 17, wherein the request includes a starting position or a starting area where or within which the remote control of the motor vehicle is to begin when the motor vehicle is located at the starting position or within the starting area, and wherein based on the request being able to be met, the remote control signals are generated and output such that the remote control may begin when the motor vehicle is in the starting position or within the starting area.

19. The method as recited in claim 17, wherein the request includes an end position or an end area where or within which the remote control of the motor vehicle is to be terminated when the motor vehicle is located at the end position or within the end area, and wherein based on the request being able to be met, the remote control signals are generated and output in such a way that the remote control can be terminated when the motor vehicle is located at the end position or within the end area.

20. The method as recited in claim 17, wherein prior to a termination of the remote control of the motor vehicle, further request signals are generated and output which represent a further request to the motor vehicle and/or to a driver of the motor vehicle that the at least semi-automated, remote guidance is to be transferred back to motor vehicle or to the driver, and wherein the remote control of the motor vehicle is terminated as a function of a response to the further request.

21. The method as recited in claim 20, wherein if a response from the motor vehicle and/or the driver to the further request is absent, the generation of the remote control signals includes generating those for a remotely controlled transfer of the motor vehicle to a safe state in order to transfer the motor vehicle by remote control to a safe state based on the generated remote control signals.

22. The method as recited in claim 20, wherein in the absence of a response from the motor vehicle and/or the driver to the further request, light-signal system control signals for controlling one or a plurality of light signal systems located in an area surrounding the motor vehicle are generated and output in such a way that, when one or a plurality of light signal systems are controlled, they are able to block traffic for the motor vehicle via signal patterns thereof.

23. The method as recited in claim 20, wherein the checking of whether the request can be met includes a check whether one or a plurality of conditions is met, the request being met only if one or more or a plurality or all of the one or the plurality of conditions are met.

24. The method as recited in claim 23, wherein the one or the plurality of conditions being an element selected from the following group of conditions, respectively: (i) an apparatus for the at least semi-automated guidance of a motor vehicle, which performs the steps of the method for the at least semi-automated guidance of a motor vehicle is in operation and fully functional, (ii) actual weather corresponds to a desired weather, (iii) actual traffic condition in an area surrounding the motor vehicle corresponds to a desired traffic condition, (iv) actual traffic infrastructure in an area surrounding the motor vehicle corresponds to a desired traffic infrastructure, (v) a computing capacity of the apparatus for the at least semi-automated guidance of a motor vehicle is equal to or greater than or equal to a predetermined computing capacity threshold value, (vi) the apparatus for the at least semi-automated guidance of a motor vehicle is able to remotely control the requesting motor vehicle, (vii) the requesting motor vehicle is able to be remotely controlled, (viii) necessary conditions for a proper functioning of the remote control are fulfilled, (ix) implementation of the remote control has been paid.

25. The method as recited in claim 17, wherein indicator signals are output, which represent an indication that an at least semi-automated guidance of a motor vehicle from a remote location is possible and/or specified.

26. The method as recited in claim 17, wherein the remote control of the motor vehicle is begun while the motor vehicle is moving or while it is stationary and/or the remote control of the motor vehicle is terminated while the motor vehicle is moving or while it is stationary.

27. A method for the at least semi-automated guidance of a motor vehicle, comprising the following steps:
during an at least semi-automated, remotely controlled, lateral and longitudinal guidance of the motor vehicle, in order for the motor vehicle to be guided in an at least semi-automated manner:
receiving request signals, which represent a request to the remotely controlled motor vehicle and/or to a driver of the remotely controlled motor vehicle that the at least semi-automated, remote guidance is to be transferred back to the motor vehicle or to the driver;
checking, in response to the receipt of the request signals, whether the2 request can be met;
based on the request being able to be met, generating control signals for the at least semi-automated control of a lateral and longitudinal guidance of the motor vehicle; and outputting the generated control signals to guide the motor vehicle in an at least semi-automated manner based on the generated control signals.

28. The method as recited in claim 27, wherein the checking whether the request can be met includes a check whether one or a plurality of conditions is met, the request being met only if one or more or a plurality or all of the one or the plurality of conditions are met.

29. The method as recited in claim 28, wherein the one or the plurality of conditions being an element selected from the following group of conditions, respectively: (i) an onboard apparatus for the at least semi-automated guidance of the motor vehicle, which is able to perform the steps of the method for the at least semi-automated guidance of a motor vehicle, is in operation and fully functional, (ii) actual weather corresponds to a desired weather, (iii) actual traffic condition in an area surrounding the motor vehicle corresponds to a desired traffic condition, (iv) actual traffic infrastructure in an area surrounding the motor vehicle corresponds to a desired traffic infrastructure, (v) a computing capacity of the onboard apparatus for the at least semi-automated guidance of the motor vehicle is equal to or greater than or equal to a predetermined computing capacity threshold value, (vi) the onboard apparatus for the at least semi-automated guidance of the motor vehicle is able to take over the at least semi-automated guidance.

30. An apparatus for the at least semi-automated guidance of a motor vehicle, the apparatus configured to:
receive request signals, which represent a request from the motor vehicle that the motor vehicle is to be remotely controlled in order for the motor vehicle to be guided in an at least semi-automated manner;
check, in response to receipt of the request signals, whether the request may be met;
based on the request being able to be met, generate remote control signals for the at least semi-automated remote control of a lateral and longitudinal guidance of the motor vehicle; and
output the generated remote control signals to guide the motor vehicle in an at least semi-automated manner from a remote location based on the generated remote control signals.

31. A non-transitory machine-readable storage medium on which is stored a computer program for the at least semi-automated guidance of a motor vehicle, the computer program, when executed by a computer, causing the computer to perform the following steps:
receiving request signals, which represent a request from the motor vehicle that the motor vehicle is to be remotely controlled in order for the motor vehicle to be guided in an at least semi-automated manner;
checking, in response to receipt of the request signals, whether the request may be met;
based on the request being able to be met, generating remote control signals for the at least semi-automated remote control of a lateral and longitudinal guidance of the motor vehicle; and
outputting the generated remote control signals to guide the motor vehicle in an at least semi-automated manner from a remote location based on the generated remote control signals.
